(19) United States
(12) Patent Application Publication
(10) Pub. No.: US 2008/0052544 A1
(43) Pub. Date: Feb. 28, 2008

(54) PORTABLE ELECTRONIC DEVICE USING A PLURALITY OF POWER SOURCES

(76) Inventors: Hsiang-An Hsieh, Taipei County (TW); Li-Pai Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/467,912

(22) Filed: Aug. 28, 2006

(51) Int. Cl. G06F 1/00

(52) U.S. Cl. 713/300

(57) ABSTRACT

A portable electronic device that can use a dc power and a renewable energy as power supplies. The portable electronic device includes a rechargeable battery as a spare power when the ac power is not available, a power management unit, and a plurality of loads. The power management unit selectively respectively couples the plurality of loads to the power supplies according to a status of each of the power supplies, the amount of power each load requires, and design considerations.

### BACKGROUND OF THE INVENTION

1. Field of the Invention

The present invention relates to a portable electronic device, and more particularly, to a portable electronic device, which can selectively use more than one power source as a power supply.

2. Description of the Prior Art

Please refer to FIG. 1. FIG. 1 is a diagram illustrating a conventional portable electronic device. As shown in FIG. 1, a conventional portable electronic device 100 comprises a power management unit 101, a battery 105, and 3 loads 102, 103, and 104. Loads 102, 103, and 104 are coupled to a power management unit 101 for receiving power. The battery 105 is coupled to the power management unit 101 for receiving power and transmitting power. The power management unit 101 is coupled to ac/dc adaptor 110 for receiving direct-current power. The operation condition is described as follows.

When ad/dc adaptor 110 is coupled to the ac socket 120 through the ac plug 111 and the power management unit 101 is coupled to the ac/dc adaptor 110, the ad/dc adaptor 110 receives an ac power and then the ad/dc adaptor 110 converts the ac power into a first dc power transmitted to the power the management unit 101. After receiving the first dc power, the power management unit 101 distributes the first dc power to loads 102, 103, 104, and the battery 105 so that loads 102, 103, 104 can operate regularly by the first dc power and the battery 105 can be charged by the first dc power.

When the ac/dc adaptor 110 is not coupled to the ac socket 120 through the ac plug 111 or when the power management unit 101 is not coupled to the ac/dc adaptor 110, the power management unit 101 receives no dc power from the ac/dc adaptor 101. Thus, the battery 105 starts to discharge and provides a second dc power. Then power management unit 101 distributes the second dc power to loads 102, 103, and 104 so that loads 102, 103, 104 can operate regularly until the second power is exhausted from the battery.

The disadvantage of the conventional portable electronic device is that it is not flexible when choosing power supplies. As the described above, the conventional portable electronic device uses an ac power through an ac/dc adaptor as a power supply, which is limited by the forms of powers. Only if the ac power is not available does the portable electronic device switch to using the battery for sustaining the regular operation of the loads. If the battery is low, the portable electronic device must be shut down. Therefore, the conventional portable electronic device cannot operate for an extended period if there is no ac power and makes inefficient use of available power sources.

### SUMMARY OF THE INVENTION

It is therefore a primary objective of the claimed invention to provide a portable electronic device to solve the above-stated problems.

According to the claimed invention, a portable electronic device includes a plurality of circuit loads, each circuit load having a first input end for receiving a power, and a power management unit including a plurality of second input ends and a plurality of first output ends. Each second input end is coupled to a corresponding power source of a plurality of power sources and each first output end is coupled to a corresponding first input end of the plurality of circuit loads. The power management unit selectively couples at least one of the plurality of first output ends to one of the plurality of second input ends or to another of the plurality of second input ends according to a power status of each of the plurality of power sources, a load level of the plurality of circuit loads, and design considerations.

It is an advantage that the claimed invention selectively couples loads to power sources according to a power status of each of the plurality of power sources, a load level of the plurality of circuit loads, and design considerations, extending battery life, extending usability duration when no ac power is available, reducing energy costs, and providing more convenience to the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional portable electronic device.

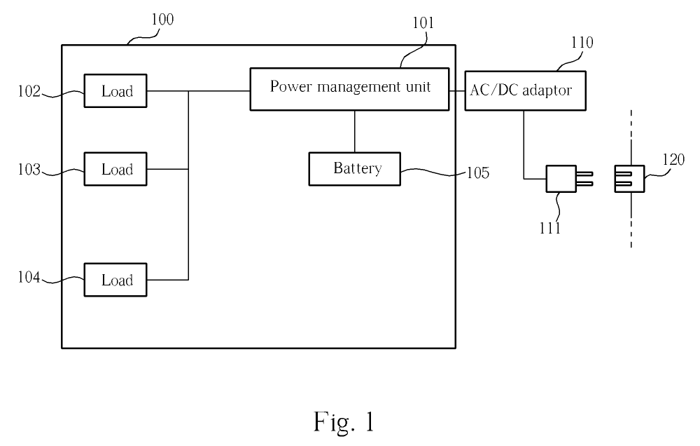

FIG. 2 is a first embodiment of a portable electronic device of the present invention.

FIG. 3 is a second embodiment of a portable electronic device of the present invention.

FIG. 4 is a diagram illustrating the behavior of the portable electronic device of the second embodiment of the present invention when an ac power and a renewable energy are both available.

FIG. 5 is a diagram illustrating the behavior of the portable electronic device of the second embodiment of the present invention when the ac power is not available, the renewable energy is available, and the battery is low.

FIG. 6 is a diagram illustrating the behavior of the portable electronic device of the second embodiment of the present invention when ac power is not available, renewable energy is available, and battery is charged.

FIG. 7 is a diagram illustrating the behavior of the portable electronic device of the second embodiment of the present invention when ac power is not available, renewable energy is available, and there is no load.

FIG. 8 is a third embodiment of the portable electronic device of the present invention.

### DETAILED DESCRIPTION

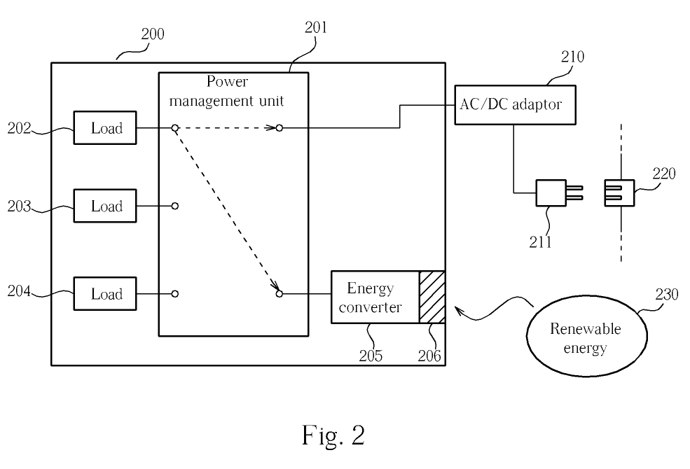

Please refer to FIG. 2. FIG. 2 is a first embodiment of a portable electronic device of the present invention. As shown in FIG. 2, the portable electronic device 200 comprises a power management unit 201, an energy converter 205, an energy receiver 206, and loads 202, 203, 204. The loads 202, 203, 204 may be electrically isolated from each other and are effectively individually coupled to the power management unit 201 for receiving power. The energy receiver 206 is coupled to the energy converter 205 for receiving a renewable energy 230 and transmitting it to the energy converter 205. The energy converter 205 is coupled to the power management unit 201 for converting the renewable energy 230 into a dc power transmitted to the power management unit 201. The power management unit 201 is coupled to an ac/dc adaptor 210 for receiving dc powers and managing the connections between the ac/dc adaptor 210, energy converter 205, and loads 202, 203, and 204. The operation condition is described as follows.

When the ac/dc adaptor 210 is coupled to an ac socket 220 through an ac plug 211 and the power management unit 201 is coupled to the ad/dc adaptor 210, the ad/dc adaptor 210 receives an ac power and then converts the ac power into a first dc power transmitted to the power management unit 201. After receiving the first dc power, the power management unit 201 can connect the ac/dc adaptor 210 to loads 202, 203, and 204, and distribute the first dc power to loads 202, 203, 204 so that loads 102, 103, 104 can operate regularly by the first dc power.

When the energy receiver 206 receives the renewable energy 230, the energy converter 205 converts the renewable energy 230 into a second dc power transmitted to power management unit 201. After receiving the second dc power, the power management unit 201 can connect the energy converter 205 to loads 202, 203, and 204, and distribute the second dc power to loads 202, 203, 204 so that loads 202, 203, 204 can operate regularly by the second dc power.

When the ac/dc adaptor 210 is coupled to the ac socket 220 through the ac plug 211 and the power management unit 201 is coupled to the ad/dc adaptor 210, and the energy receiver 206 receives the renewable energy 230, the ad/dc adaptor 210 receives an ac power and then converts the ac power into the first dc power transmitted to the power management unit 201, and the energy converter 205 converts the renewable energy 230 into a second dc power transmitted to the power management unit 201. After receiving the first and second dc powers, because in general ac power is more stable than renewable energy 230, the power management unit 201 may couple the ac/dc adaptor 210 to loads 202, 203, and 204, and distribute only the first dc power to loads 202, 203, 204 while ignoring the received second power so that loads 202, 203, 204 can operate regularly by the first dc power. However, the power management unit 201 may couple the energy converter 205 to loads 202, 203, and 204, and distribute only the second dc power to loads 202, 203, 204 while ignoring the received first power. Alternately, the power management unit 205 may couple a portion of the loads 202, 203, 204 to the first dc power and a different portion of the loads 202, 203, 204 to the second dc power. The power management unit 205 determines the status of available power sources and the level of each of the loads 202, 203, 204, meaning the amount of power each of the loads 202, 203, 204 individually requires, and selectively couples each of the loads 202, 203, 204 to either the first dc power or to the second dc power. The relative levels of each of the loads 202, 203, 204 are obviously subject to design considerations.

The portable electronic device 200 can be a notebook pc, a PDA (personal digital assistant), or any other form electronic devices using more than one power source. The renewable energy 230 can be solar energy or light. The energy converter 205 and energy receiver 206 may be fixed to or detachable of the portable electronic device 200. The loads 202, 203, 204 can be a keyboard, a screen, and a mouse. Though the amount of loads of the portable electronic device 200 is only 3, the number 3 is only an example and is not limiting as the spirit of the invention is intended to cover situations when the amount of loads is more than 3 or less than 3.

Thus, portable electronic device 200 is more flexible when choosing powers as power supplies than the conventional portable electronic device. When there is no ac power, portable electronic device 200 may still use renewable energy 230 to operate regularly. When the ac power exists, energy costs may be reduced by the amount of power supplied by the renewable energy 230.

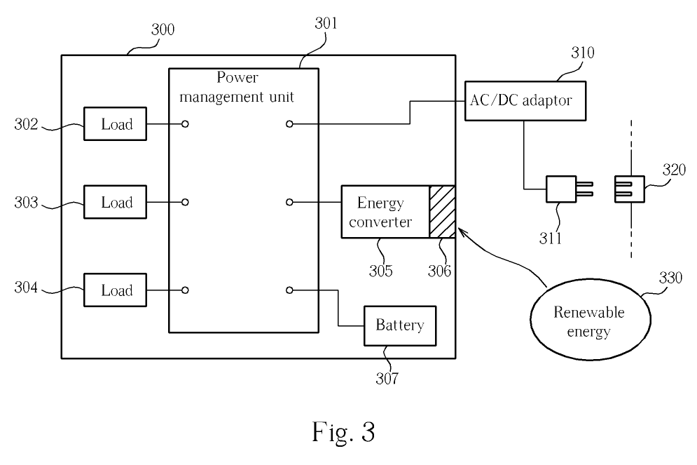

Please refer to FIG. 3. FIG. 3 is a second embodiment of a portable electronic device of the present invention. As shown in FIG. 3, portable electronic device 300 comprises a power management unit 301, an energy converter 305, an energy receiver 306, a battery 307, and loads 302, 303, 304. The loads 302, 303, 304 may be each be electrically isolated and are coupled to the power management unit 301 for receiving power. The energy receiver 306 is coupled to the energy converter 305 for receiving renewable energy 330 and transmitting it to the energy converter 305. The energy converter 305 is coupled to the power management unit 201 for converting the renewable energy 330 into a dc power. The battery 307 is coupled to the power management unit 301 for providing a spare dc power when needed. The power management unit 301 is coupled to the ac/dc adaptor 310 for receiving dc powers and managing couplings between the ac/dc adaptor 310, the energy converter 305, the battery 307, and the loads 302, 303, and 304. The operation condition is described as follows.

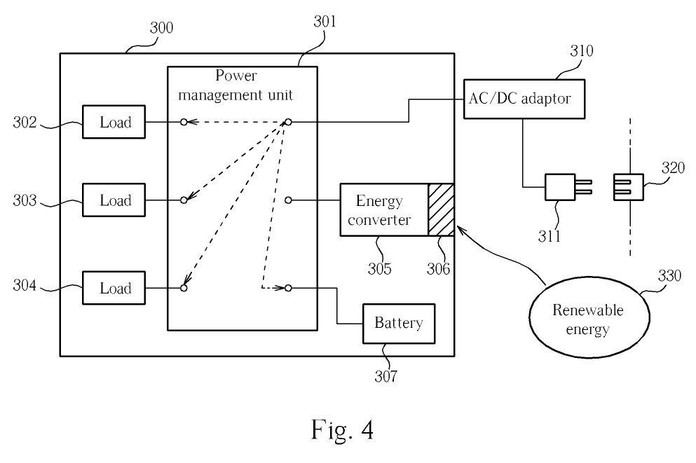

Please refer to FIG. 4. FIG. 4 shows the behavior of the portable electronic device 300 of the second embodiment of the present invention when an ac power and a renewable energy are both available. When the ac/dc adaptor 310 is coupled to the ac socket 320 through the ac plug 311 and the power management unit 301 is coupled to the ad/dc adaptor 310, and the energy receiver 306 receives the renewable energy 330, the ad/dc adaptor 310 receives an ac power and then converts the ac power into a first dc power transmitted to the power management unit 301, and the energy converter 305 converts the renewable energy 330 into a second dc power transmitted to the power management unit 301. After receiving the first and second dc powers, the power management unit 301 may connect the ac/dc adaptor 310 to loads 302, 303, and 304, and distribute only the first dc power to loads 302, 303, 304 and the battery 307 while ignoring the received second power so that loads 302, 303, 304 can operate regularly while battery 307 is charged by the first dc power. This is also the same condition when the ac/dc adaptor 310 is coupled to the ac socket 320 through the ac plug 311 and the power management unit 301 is coupled to the ad/dc adaptor 310 but the renewable energy 330 is not available.

However, due to design considerations and efficient use of power, as with all other embodiments of the present invention, the power management unit 301 may selectively couple a portion of the loads 302, 303, 304 (and/or the battery 307) to the first dc power and a different portion of the loads 302, 303, 304 (and/or the battery 307) to the second dc power, or optionally couple all loads 302, 303, 304 and/or the battery 307 to the second dc power. The power management unit 301 determines the status of available power sources and the level of each of the loads 302, 303, 304, meaning received voltage levels of the respective power sources and the amount of power each of the loads 302, 303, 304 individually requires, and selectively couples each of the loads 302, 303, 304 to either the first dc power or to the second dc power according to the status of the power supplies, load levels, and predetermined design considerations.

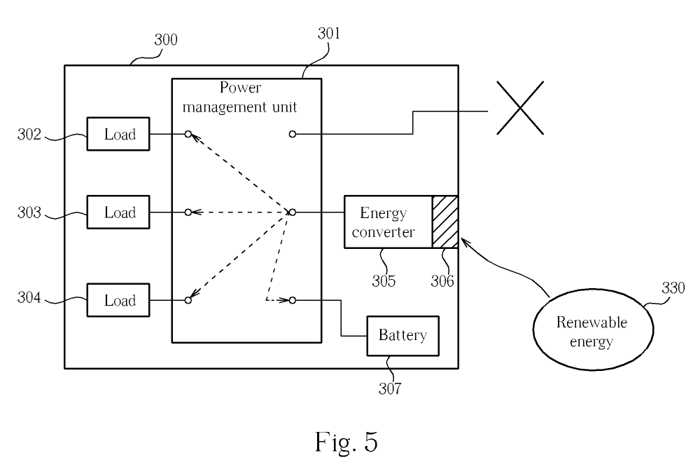

Please refer to FIG. 5. FIG. 5 shows the behavior of the portable electronic device 300 of the second embodiment of the present invention when the ac power is not available, the renewable energy is available, and the battery is low. When the energy receiver 306 receives the renewable energy 330, the energy converter 305 converts the renewable energy 330 into a second dc power transmitted to the power management unit 301. After receiving the second dc power, power management unit 301 may couple the energy converter 305 to loads 302, 303, and 304, and distribute the second dc power to loads 302, 303, 304, and the battery 307 so that loads 302, 303, 304 can operate regularly and battery 307 is charged by the second dc power. If the second dc power cannot afford all loads 302, 303, 304, and the battery 307, the power management unit 301 may stop charging battery 307 and distribute the second dc power only to loads 302, 303, and 304. If the second dc power still cannot afford loads 302, 303, 304, the power management unit 301 may selectively connect at least one of loads 302, 303, 304 to energy converter 305. In this way, some loads of 302, 303, 304 may not be provided with dc power and are unable to work. Thus the portable electronic device 300 enters a power-saving mode to lower the power consumption of all loads. Again, the power management unit 301 determines the status of available power sources and the level of each of the loads 302, 303, 304 and may selectively couple the loads 302, 303, 304, and/or the battery 307 to the second dc power.

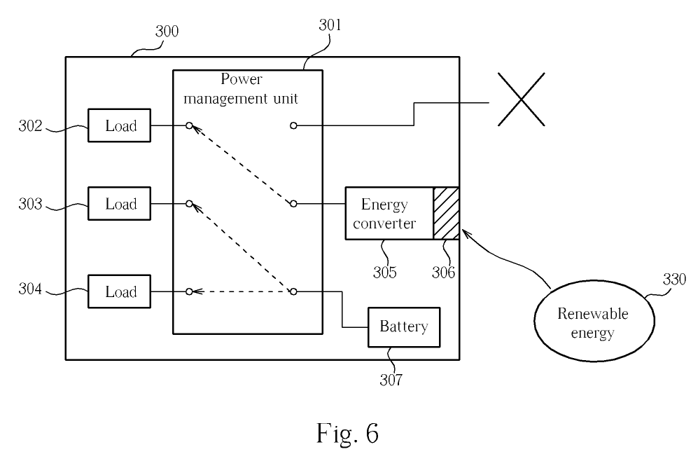

Please refer to FIG. 6. FIG. 6 shows the behavior of the portable electronic device 300 of the second embodiment of the present invention when ac power is not available, renewable energy is available, and battery is charged. When the energy receiver 306 receives the renewable energy 330, the energy converter 305 converts the renewable energy 330 into a second dc power transmitted to the power management unit 301. Meanwhile, the battery 307 is discharged providing a third dc power. After receiving the second and third dc powers, the power management unit 301 may connect the energy converter 305 and the battery 307 respectively and selectively to loads 302, 303, and 304, and distribute the second and third dc power to loads 302, 303, 304 according to the power consumption of each load so that loads 302, 303, 304 can operate regularly. For example, if the second dc power can afford loads 302 and 303, power management unit 301 couples the energy converter 305 to loads 302 and 304, transmits the second dc power to loads 302 and 303 while the power management unit 301 connects battery 307 to load 304 for transmitting the third dc power to load 304. But if the second dc power can afford loads 302, 303, 304, and battery 307, power management unit 301 may couple loads 302, 303, 304, and battery 307 to energy converter 305. At this time, battery 307 is charged. The power management unit 301 determines the status of available power sources and the level of each of the loads 302, 303, 304 and selectively couples the loads 302, 303, 304, and/or the battery 307 to the second dc power and or third dc power.

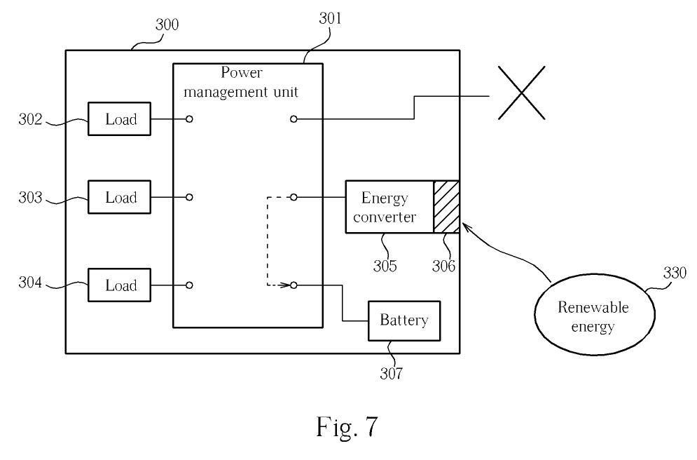

Please refer to FIG. 7. FIG. 7 shows the behavior of the portable electronic device 300 of the second embodiment of the present invention when ac power is not available, renewable energy is available, and there is no load. When the energy receiver 306 receives the renewable energy 330, the energy converter 305 converts the renewable energy 330 into a second dc power transmitted to the power management unit 301. After receiving the second dc power, power management unit 301 uses the second dc power to charge battery 307. This condition happens when portable electronic device 300 is shut down but energy converter 305 and related devices still work.

The portable electronic device 300 can be a notebook pc, a PDA (personal digital assistant), or any other form electronic devices using more than one power sources. Renewable energy 330 can be solar energy or light. The energy converter 305 and the energy receiver 306 may comprise a solar panel and may be detachable of portable electronic device 300. A detachable energy receiver 306 may allow power generated from the renewable energy source to be maximum more easily. Loads 302, 303, 304 can be a keyboard, a screen, and a mouse. It is to be understood that the number of loads covered by the scope of the invention is not limited to 3, nor are the specific loads limited to those used in the example descriptions.

Thus, portable electronic device 300 is more flexible when choosing powers as power supplies than the conventional portable electronic device. When there is no ac power, portable electronic device 300 still uses renewable energy 330 and the battery 307 to operate regularly. The advantage of portable electronic device 300 is that loads 302, 303, and 304 can be selectively shared by the ac/dc adapter 310, the energy converter 305, and/or the battery 307. Thus, in this condition, the portable electronic device 300 can extend battery life and reduce energy costs over the conventional portable electronic device.

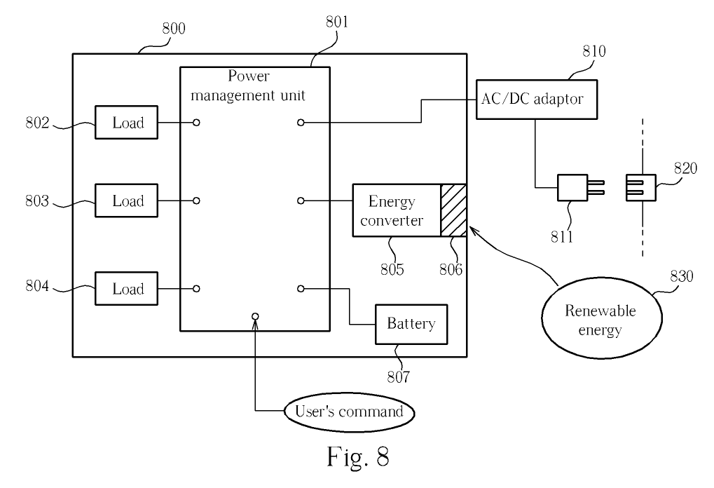

Please refer to FIG. 8. FIG. 8 is a third embodiment of the portable electronic device 800 of the present invention. As shown in FIG. 8, portable electronic device 800 is the same as the portable electronic device 300. The only difference between portable electronic device 300 and portable electronic device 800 is that the power management unit 801 of the portable electronic device 800 is additionally provided with a node to receive a user's command. The operation condition of portable electronic device 800 is also the same as portable electronic device 300 except the behavior of power management unit 801 can be re-defined according to the user's command. For example, the user can command power management unit 801 to couple ac/dc adaptor 810 only to load 802, to couple energy converter 805 only to load 803, and to couple battery 807 only to load 804. The power management unit 801 can selectively couple different powers to different loads according to the user's preference.

The portable electronic device 800 can be a notebook pc, a PDA (personal digital assistant), or any other form electronic devices using more than one power source. The renewable energy 830 can be solar energy or light. The energy converter 805 and the energy receiver 806 may comprise a solar panel and may be detachable of portable electronic device 800. Loads 802, 803, 804 can be keyboard, screen, and mouse. Though the amount of loads of the portable electronic device 800 is not limited to 3.

Thus, portable electronic device 800 is more flexible when choosing powers as power supplies then the conventional portable electronic device. When there is no ac power, portable electronic device 800 still uses renewable energy 830 and the battery 807 to operate regularly. The advantage of the portable electronic device 800 is that the ac power, the energy converter 805, and the battery 807 share loads 802, 803, and 804. Thus, in this condition, portable electronic device 800 can work longer and more efficiently than the conventional portable electronic device. Additionally, the power management unit 801 can selectively couple loads with power sources according to a user's preference, which provides much convenience to the user.

The present invention discloses a portable electronic device that can selectively and individually couple a plurality of loads of the portable electronic device to one or another of a plurality of power supplies according to a status of each of the power supplies, the amount of power each load requires, and predetermined design considerations. The status of a power supply may be a voltage or current level that the portable electronic device receives from the power supply. The level of a load may be the total amount of power necessary to operate normally the load, or may also be subject to design considerations. Through selective coupling of loads and power supplies, battery life may be extended, energy cost reduced, and convenience provided to the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a plurality of circuit loads, each circuit load having a first input end for receiving a power; and
a power management unit comprising:
a plurality of second input ends, each second input end coupled to a corresponding power source of a plurality of power sources; and
a plurality of first output ends, each first output end coupled to a corresponding first input end of the plurality of circuit loads, the power management unit selectively coupling at least one of the plurality of first output ends to one of the plurality of second input ends or to another of the plurality of second input ends according to a power status of each of the plurality of power sources and a load level of the plurality of circuit loads.

2. The device of claim 1, wherein the plurality of power sources comprises an ac power.

3. The device of claim 1, further comprising a power converter coupled between one of the plurality of power sources and the corresponding second input end of the power management unit.

4. The device of claim 3, wherein the power converter is an ac/dc converter converting ac power to dc power.

5. The device of claim 1, wherein the plurality of power sources comprises a dc power.

6. The device of claim 5, wherein a power converter coupled between the dc power and the corresponding second input end of the power management unit is a dc/dc converter converting a dc power to a dc power.

7. The device of claim 1, wherein the plurality of power sources comprises a device converting a renewable energy into electricity.

8. The device of claim 7, wherein the device converting a renewable energy into electricity comprises a solar panel.

9. The device of claim 8, wherein the portable electronic device further comprises a housing, and the solar panel is detachably fixed to a surface of the housing.

10. The device of claim 8, wherein the portable electronic device further comprises a housing, and the solar panel is fixed to a surface of the housing.

11. The device of claim 1, wherein the power status of each of the plurality of power sources comprises a voltage level.

12. The device of claim 1, wherein the load level of the plurality of circuit loads comprises a summation of the plurality of circuit loads.

13. The device of claim 1, wherein the load level of the plurality of circuit loads comprises power consumption of the plurality of circuit loads.

14. The device of claim 1, further comprising a battery as one of the plurality of power sources.

15. The device of claim 14, wherein the battery is a rechargeable battery.

16. The device of claim 15, wherein the power management unit further comprises a transmission end coupled to the battery.

17. The device of claim 16, wherein the power management unit selectively further couples the transmission end of the power management unit to one of the plurality of second input ends of the power management unit according to the power status of each of the plurality of power sources and the load level of the plurality of circuit loads.

18. The device of claim 16, wherein the power management unit selectively further couples the transmission end of the power management unit to at least one of the plurality of first output ends of the power management unit according to the power status of each of the plurality of power sources and the load level of the plurality of circuit loads.

19. The device of claim 1, wherein the power management unit further comprises a third input end, receiving a command from a user.

20. The device of claim 19, wherein the power management unit further selectively couples at least one of the plurality of first output ends to at least one of the plurality of second input ends according to the command from the user.

21. The device of claim 1, wherein the portable electronic device is a notebook pc.

22. The device of claim 1, wherein the plurality of circuit loads comprises a keyboard.

23. The device of claim 1, wherein the plurality of circuit loads comprises a display screen.

24. The device of claim 1, wherein the plurality of circuit loads comprises a computer system.
